(19) United States
(12) Patent Application Publication
(10) Pub. No.: US 2021/0092524 A1
(43) Pub. Date: Mar. 25, 2021

(54) VIBRATION PLATE HAVING REINFORCED STRUCTURAL ELEMENT AND SPEAKER USING THE SAME

(71) Applicant: Eastech (Huiyang) Co., Ltd., Guangdong (CN)

(72) Inventors: Kheng-Wee LEE, Guangdong (CN); Cheng CHEN, Guangdong (CN)

(21) Appl. No.: 16/799,858

(22) Filed: Feb. 25, 2020

(30) Foreign Application Priority Data
Sep. 19, 2019 (CN) 201910886338.4

(51) Int. Cl. H04R 7/14; H04R 7/16

(52) U.S. Cl. CPC H04R 7/14; H04R 7/16; H04R 2400/11; H04R 9/025; H04R 2307/025; H04R 2307/023; H04R 2307/027; H04R 2307/021

(57) ABSTRACT

A vibration plate having a reinforced structural element is provided. The vibration plate includes a vibration plate main body. The vibration main body has a first surface and a second surface opposite to each other. The reinforced structural element is located between the first surface and the second surface. A material of the vibration plate main body is different from a material of the reinforced structural element.

### RELATED APPLICATIONS

This application claims priority to Chinese Application Serial Number 201910886338.4, filed Sep. 19, 2019, which is herein incorporated by reference.

### BACKGROUND

### Technical Field

The present disclosure relates to vibration plates having a reinforced structural element. More particularly, the present disclosure relates to vibration plates utilized in speakers.

### Description of Related Art

Music is an important product of human civilization. With the improvement of living standards of people, the types of equipment related to music have become more and more diverse. Among those equipment, speaker is an important device which can greatly increase the sound volume. Apart from the applications in music, users can also use speakers to allow more listeners to hear the message that the users wants to deliver.

However, apart from effectively amplifying the sound volume, how to avoid distortion of the amplified sound is undoubtedly a topic of great concern in the industry.

### SUMMARY

A technical aspect of the present disclosure is to provide a vibration plate having a reinforced structural element and being particularly utilized in a speaker. The reinforced structural element can effectively maintain the shape of the vibration plate, such that the chance of sound distortion of the speaker is reduced.

According to an embodiment of the present disclosure, a vibration plate having a reinforced structural element is provided. The vibration plate includes a vibration plate main body. The vibration plate main body has a first surface and a second surface opposite to each other. The reinforced structural element is located between the first surface and the second surface. A material of the vibration plate main body is different from a material of the reinforced structural element.

In one or more embodiments of the present disclosure, the material of the vibration plate main body includes one of paper, polypropylene, rubber, ceramic, glass fiber, aluminum, titanium, beryllium, magnesium-lithium alloy or any combination thereof.

In one or more embodiments of the present disclosure, the material of the reinforced structural element includes one of carbon fiber, mica, titanium, magnesium-lithium alloy or any combination thereof.

In one or more embodiments of the present disclosure, the reinforced structural element is in a shape of a cylinder.

In one or more embodiments of the present disclosure, the reinforced structural element has a cross-sectional diameter ranging between 0.5 mm and 1.5 mm.

In one or more embodiments of the present disclosure, the reinforced structural element extends towards a center of the vibration plate main body.

In one or more embodiments of the present disclosure, an extension direction of the reinforced structural element deviates from a center of the vibration plate main body.

In one or more embodiments of the present disclosure, the reinforced structural element is in a shape of a flake.

In one or more embodiments of the present disclosure, the reinforced structural element has a thickness ranging between 0.1 mm and 1.0 mm.

In one or more embodiments of the present disclosure, the reinforced structural element is in a shape of a curve or a circle.

In one or more embodiments of the present disclosure, the reinforced structural element includes a first subsidiary reinforced structural element and a second subsidiary reinforced structural element, the first subsidiary reinforced structural element extends towards a center of the vibration plate main body, the second subsidiary reinforced structural element is in a shape of a curve, the first subsidiary reinforced structural element connects to a portion of the second subsidiary reinforced structural element between two ends of the second subsidiary reinforced structural element.

According to an embodiment of the present disclosure, a speaker includes a base frame and a vibration plate. The vibration plate is disposed above the base frame. The vibration plate includes a vibration plate main body and a reinforced structural element. The vibration plate main body has a first surface and a second surface opposite to each other. The reinforced structural element is located between the first surface and the second surface. A material of the vibration plate main body is different from a material of the reinforced structural element.

When compared with the prior art, the above-mentioned embodiments of the present disclosure have at least the following advantages:

(1) Through embedding the reinforced structural element inside the vibration plate, the overall stiffness of the vibration plate can be reinforced. Therefore, during the operation of the speaker, when the magnetic assembly unit makes a sound and the vibration plate at least partially vibrates, the degree of deformation of the vibration plate is effectively reduced. In other words, the shape of the vibration plate can be effectively maintained, such that the chance of sound distortion of the speaker is reduced.

(2) Since the reinforced structural element is embedded inside the vibration plate, the chance of peeling off of the reinforced structural element from the vibration plate is effectively avoided.

(3) Since a carbon fiber stick has a very light weight, the carbon stick is appropriate to be embedded inside the vibration plate main body while the overall weight of the vibration plate is not greatly increased, which effectively maintains the property of the vibration plate.

### BRIEF DESCRIPTION OF THE DRAWINGS

The disclosure can be more fully understood by reading the following detailed description of the embodiments, with reference made to the accompanying drawings as follows:

FIG. 1 is a top view of a speaker according to an embodiment of the present disclosure;

FIG. 2 is a cross-sectional view along the section line A-A of FIG. 1;

FIG. 3 is a top view of a speaker according to another embodiment of the present disclosure;

FIG. 4 is a top view of a speaker according to a further embodiment of the present disclosure;

FIG. 5 is a top view of a speaker according to another embodiment of the present disclosure;

FIG. 6 is a top view of a speaker according to a further embodiment of the present disclosure;

FIG. 7 is a top view of a speaker according to another embodiment of the present disclosure; and

FIG. 8 is a top view of a speaker according to a further embodiment of the present disclosure.

### DETAILED DESCRIPTION

Drawings will be used below to disclose embodiments of the present disclosure. For the sake of clear illustration, many practical details will be explained together in the description below. However, it is appreciated that the practical details should not be used to limit the claimed scope. In other words, in some embodiments of the present disclosure, the practical details are not essential. Moreover, for the sake of drawing simplification, some customary structures and elements in the drawings will be schematically shown in a simplified way. Wherever possible, the same reference numbers are used in the drawings and the description to refer to the same or like parts.

Unless otherwise defined, all terms (including technical and scientific terms) used herein have the same meanings as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

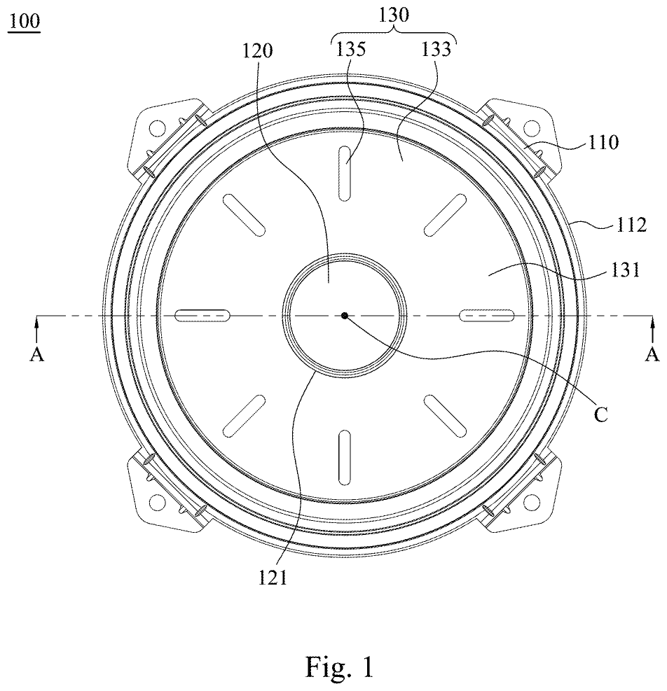

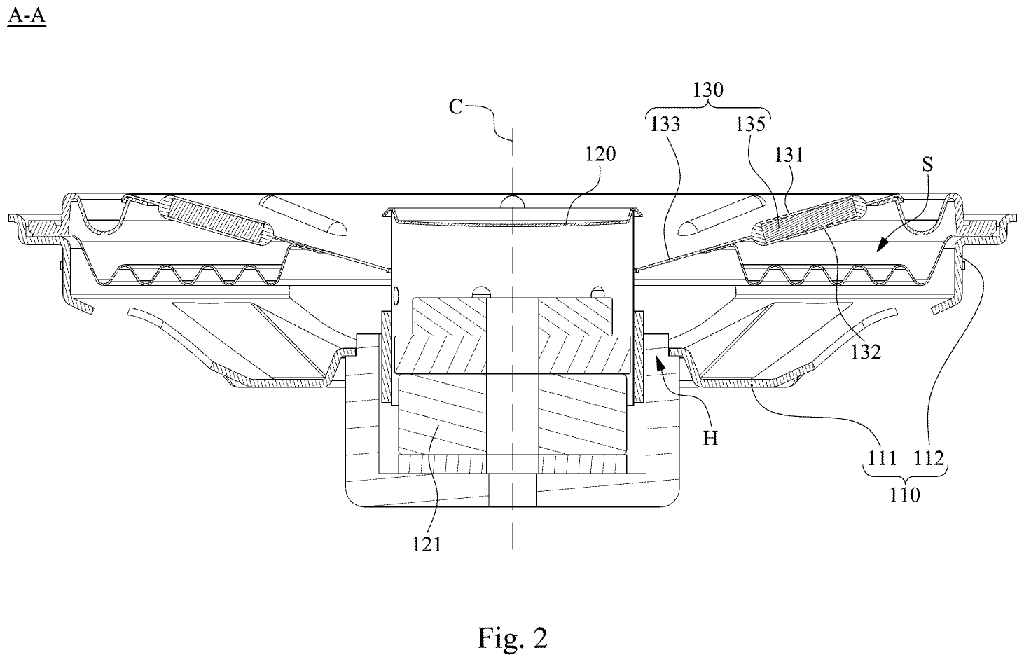

Reference is made to FIGS. 1-2. FIG. 1 is a top view of a speaker 100 according to an embodiment of the present disclosure. FIG. 2 is a cross-sectional view along the section line A-A of FIG. 1. In this embodiment, as shown in FIGS. 1-2, a speaker 100 includes a base frame 110, a magnetic assembly unit 121 and a vibration plate 130. The vibration plate 130 is disposed above the base frame 110, and the vibration plate 130 includes a vibration plate main body 133 and a reinforced structural element 135. The magnetic assembly unit 121 at least partially penetrates through the vibration plate main body 133 and is substantially located at a center of the vibration plate main body 133. The magnetic assembly unit 121 is disposed with a dust cover 120. The vibration plate main body 133 has a first surface 131 and a second surface 132 opposite to each other. The reinforced structural element 135 is located between the first surface 131 and the second surface 132. In other words, the reinforced structural element 135 is embedded inside the vibration plate main body 133. It is worth noting that, a material of the vibration plate main body 133 is different from a material of the reinforced structural element 135.

In practical applications, for instance, the material of the vibration plate main body 133 includes one of paper, polypropylene, rubber, ceramic, glass fiber, aluminum, titanium, beryllium, magnesium-lithium alloy or any combination thereof.

On the other hand, for instance, the material of the reinforced structural element 135 includes one of carbon fiber, mica, titanium, magnesium-lithium alloy or any combination thereof. As mentioned above, the material of the vibration plate main body 133 is different from the material of the reinforced structural element 135. Therefore, the vibration plate main body 133 and the reinforced structural element 135 cannot be chosen to have the same material.

In addition, the base frame 110 has a base plate 111 and a side wall 112 connected with each other. The side wall 112 surrounds to define a space S. As shown in FIG. 1, in this embodiment, the side wall 112 surrounds to form a circular shape. As shown in FIG. 2, the base plate 111 has a through hole H. The through hole H is communicated with the space S. The magnetic assembly unit 121 at least partially penetrates through the through hole H. In other words, a portion of the magnetic assembly unit 121 is located inside the space S. The magnetic assembly unit 121 is configured to make a sound. The vibration plate 130 is located inside the space S. Moreover, the vibration plate 130 is connected with the side wall 112 and the magnetic assembly unit 121.

Through embedding the reinforced structural element 135 inside the vibration plate 130, the overall stiffness of the vibration plate 130 can be reinforced. Therefore, during the operation of the speaker 100, when the magnetic assembly unit 121 makes a sound and the vibration plate 130 at least partially vibrates, the degree of deformation of the vibration plate 130 is effectively reduced. In other words, the shape of the vibration plate can be effectively maintained, such that the chance of sound distortion of the speaker 100 is reduced.

To be more specific, as shown in FIG. 2, since the reinforced structural element 135 is embedded inside the vibration plate 130, the chance of peeling off of the reinforced structural element 135 from the vibration plate 130 is effectively avoided.

In addition, as shown in FIG. 1, the reinforced structural element 135 is in a shape of a cylinder, and the reinforced structural element 135 extends towards the magnetic assembly unit 121. As mentioned above, the reinforced structural element 135 can be made of carbon fiber. In practical applications, a carbon fiber stick (which is the reinforced structural element 135) has a cross-sectional diameter ranging between 0.5 mm and 1.5 mm. Therefore, a carbon fiber stick (which is the reinforced structural element 135) has a very light weight, such that the reinforced structural element 135 is appropriate to be embedded inside the vibration plate main body 133 while the overall weight of the vibration plate 130 is not greatly increased, which effectively maintains the property of the vibration plate 130. In this embodiment, a quantity of the reinforced structural element 135 is plural, and the distance of each of the reinforced structural elements 135 from the magnetic assembly unit 121 is substantially the same as each other. Moreover, the reinforced structural elements 135 substantially extend towards a center C of the magnetic assembly unit 121. Therefore, it should be noted that, the form that the reinforced structural elements 135 to be embedded inside the vibration plate main body 133 is arranged based on a particular pattern. The reinforced structural elements 135 are not evenly or randomly distributed inside the vibration plate main body 133 as mixtures.

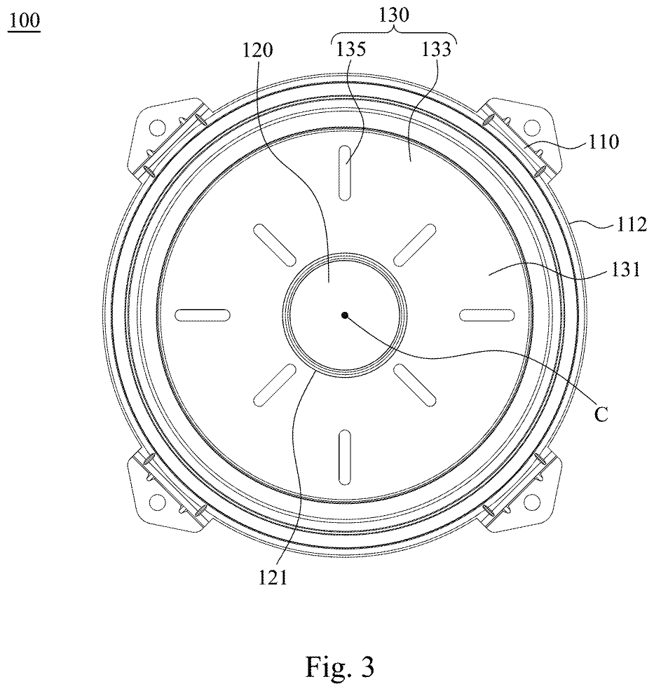

Reference is made to FIG. 3. FIG. 3 is a top view of a speaker 100 according to another embodiment of the present disclosure. In this embodiment, as shown in FIG. 3, a quantity of the reinforced structural element 135 is plural. According to the actual situation, the distance of each of the reinforced structural elements 135 from the magnetic assembly unit 121 can be different from each other.

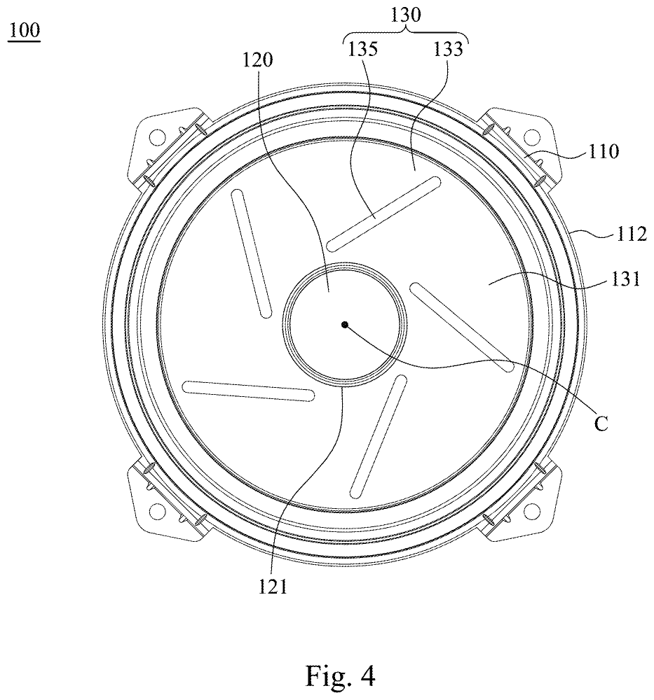

Reference is made to FIG. 4. FIG. 4 is a top view of a speaker 100 according to a further embodiment of the present disclosure. In this embodiment, as shown in FIG. 4, a quantity of the reinforced structural element 135 is plural. According to the actual situation, an extension direction of each of the reinforced structural elements 135 deviates from the center C of the magnetic assembly unit 121.

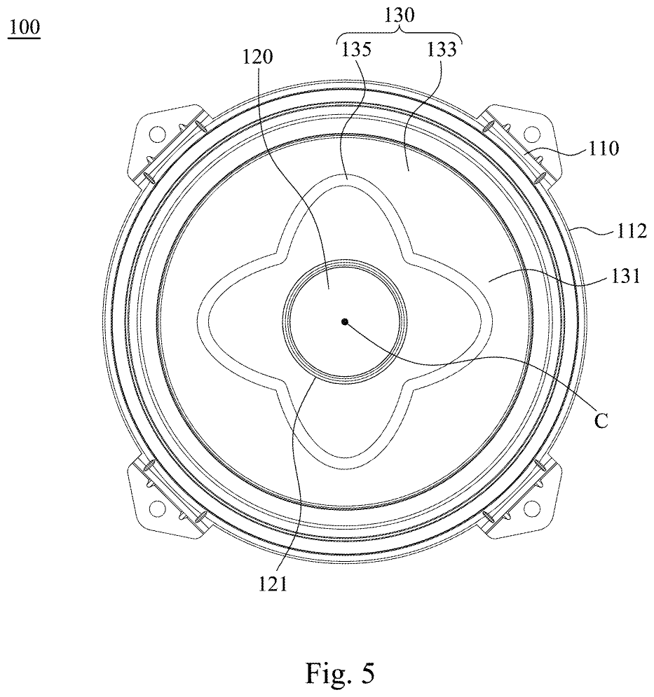

Reference is made to FIG. 5. FIG. 5 is a top view of a speaker 100 according to another embodiment of the present disclosure. In this embodiment, as shown in FIG. 5, a quantity of the reinforced structural element 135 is plural. According to the actual situation, each of the reinforced structural elements 135 is in a shape of a curve. The curved reinforced structural elements 135 are connected with each other and disposed around the magnetic assembly unit 121.

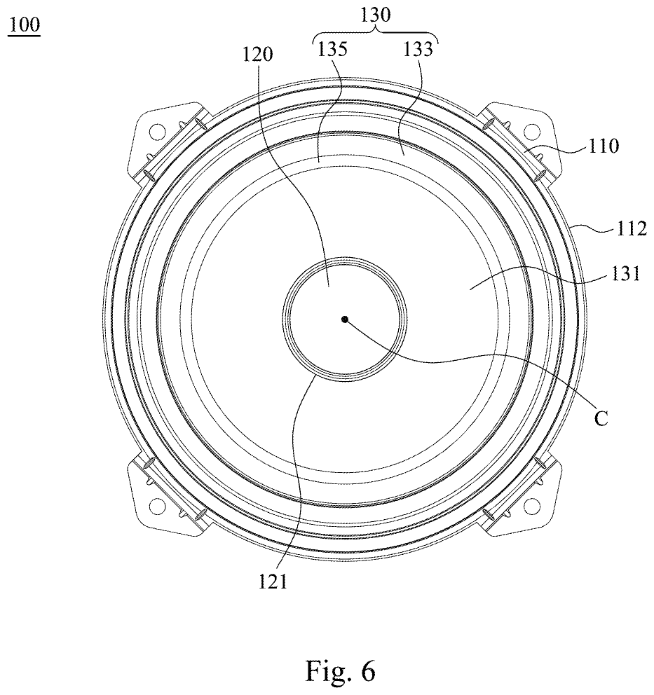

Reference is made to FIG. 6. FIG. 6 is a top view of a speaker 100 according to a further embodiment of the present disclosure. In this embodiment, as shown in FIG. 6, according to the actual situation, the reinforced structural element 135 is in a shape of a circle. The circular reinforced structural element 135 is disposed around the magnetic assembly unit 121.

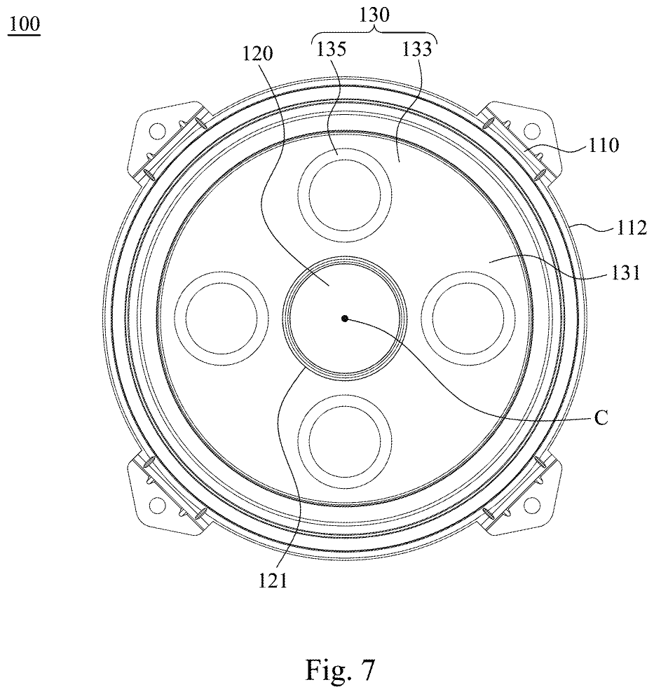

Reference is made to FIG. 7. FIG. 7 is a top view of a speaker 100 according to another embodiment of the present disclosure. In this embodiment, as shown in FIG. 7, a quantity of the reinforced structural element 135 is plural. According to the actual situation, each of the reinforced structural elements 135 is in a shape of a circle. The magnetic assembly unit 121 is located between the circular reinforced structural elements 135.

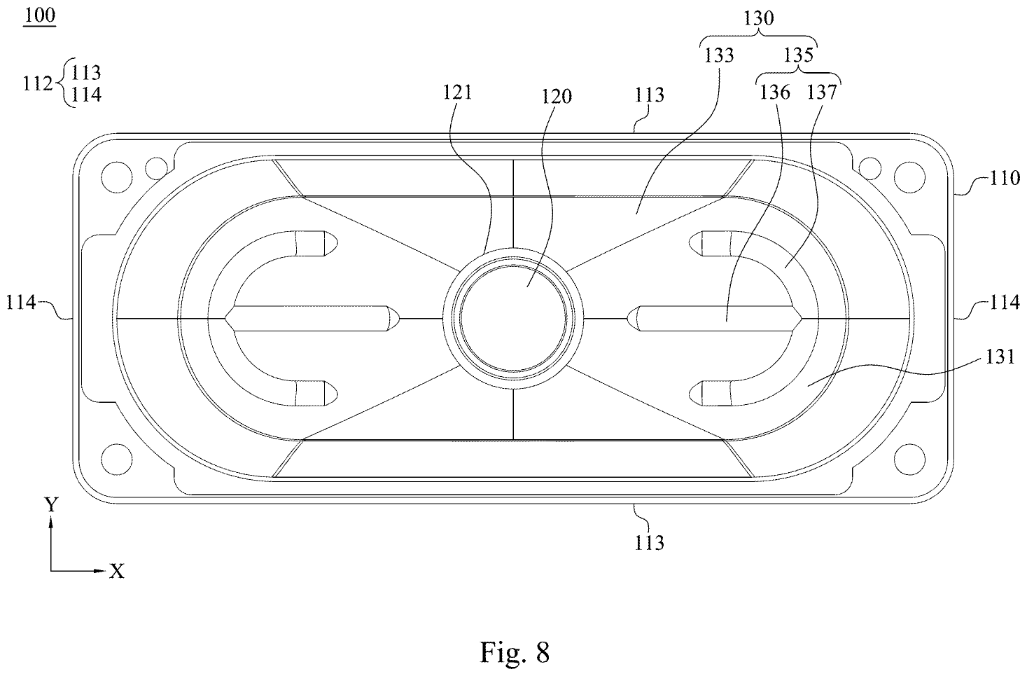

Reference is made to FIG. 8. FIG. 8 is a top view of a speaker 10 according to a further embodiment of the present disclosure. In this embodiment, the side wall 112 has two first subsidiary side walls 113 and two second subsidiary side walls 114. The first subsidiary side walls 113 extend along a direction X and are opposite to each other. Two ends of the first subsidiary side walls 113 are respectively connected with the second subsidiary side walls 114. The second subsidiary side walls 114 are opposite to each other. In other words, as shown in FIG. 8, the side wall 112 surrounds to form a rectangle. Correspondingly, the vibration plate 130 is in a shape of a rectangle.

In addition, in this embodiment, the reinforced structural element 135 includes a first subsidiary reinforced structural element 136 and a second subsidiary reinforced structural element 137. As shown in FIG. 8, the first subsidiary reinforced structural element 136 extends towards the magnetic assembly unit 121, and the second subsidiary reinforced structural element 137 is in a shape of a curve. The first subsidiary reinforced structural element 136 is connected to a portion of the second subsidiary reinforced structural element 137 between two ends of the second subsidiary reinforced structural element 137. In other words, the reinforced structural element 135 covers the direction X and a direction Y. The direction X and the direction Y are substantially perpendicular to each other. Therefore, the reinforced structural element 135 can effectively reinforce the overall stiffness of the vibration plate 130 in the direction X and the direction Y.

Furthermore, the reinforced structural element 135 is in a shape of a flake, and the reinforced structural element 135 has a thickness ranging between 0.1 mm and 1.0 mm. Moreover, in practical applications, in order to match with the curvature of the vibration plate main body 133, the first subsidiary reinforced structural element 136 and the second subsidiary reinforced structural element 137 can respectively have a particular curvature, such that the curvature of the vibration plate main body 133 can be maintained.

In conclusion, when compared with the prior art, the aforementioned embodiments of the present disclosure have at least the following advantages:

(1) Through embedding the reinforced structural element inside the vibration plate, the overall stiffness of the vibration plate can be reinforced. Therefore, during the operation of the speaker, when the magnetic assembly unit makes a sound and the vibration plate at least partially vibrates, the degree of deformation of the vibration plate is effectively reduced. In other words, the shape of the vibration plate can be effectively maintained, such that the chance of sound distortion of the speaker is reduced.

(2) Since the reinforced structural element is embedded inside the vibration plate, the chance of peeling off of the reinforced structural element from the vibration plate is effectively avoided.

(3) Since a carbon fiber stick has a very light weight, the carbon stick is appropriate to be embedded inside the vibration plate main body while the overall weight of the vibration plate is not greatly increased, which effectively maintains the property of the vibration plate.

Although the present disclosure has been described in considerable detail with reference to certain embodiments thereof, other embodiments are possible. Therefore, the spirit and scope of the appended claims should not be limited to the description of the embodiments contained herein.

It will be apparent to the person having ordinary skill in the art that various modifications and variations can be made to the structure of the present disclosure without departing from the scope or spirit of the present disclosure. In view of the foregoing, it is intended that the present disclosure cover modifications and variations of the present disclosure provided they fall within the scope of the following claims.

What is claimed is:

1. A vibration plate having a reinforced structural element, the vibration plate comprising:
a vibration plate main body having a first surface and a second surface opposite to each other, the reinforced structural element being located between the first surface and the second surface,
wherein a material of the vibration plate main body is different from a material of the reinforced structural element.

2. The vibration plate of claim 1, wherein the material of the vibration plate main body comprises one of paper, polypropylene, rubber, ceramic, glass fiber, aluminum, titanium, beryllium, magnesium-lithium alloy or any combination thereof.

3. The vibration plate of claim 1, wherein the material of the reinforced structural element comprises one of carbon fiber, mica, titanium, magnesium-lithium alloy or any combination thereof.

4. The vibration plate of claim 1, wherein the reinforced structural element is in a shape of a cylinder.

5. The vibration plate of claim 4, wherein the reinforced structural element has a cross-sectional diameter ranging between 0.5 mm and 1.5 mm.

6. The vibration plate of claim 4, wherein the reinforced structural element extends towards a center of the vibration plate main body.

7. The vibration plate of claim 4, wherein an extension direction of the reinforced structural element deviates from a center of the vibration plate main body.

8. The vibration plate of claim 1, wherein the reinforced structural element is in a shape of a flake.

9. The vibration plate of claim 8, wherein the reinforced structural element has a thickness ranging between 0.1 mm and 1.0 mm.

10. The vibration plate of claim 1, wherein the reinforced structural element is in a shape of a curve or a circle.

11. The vibration plate of claim 1, wherein the reinforced structural element comprises a first subsidiary reinforced structural element and a second subsidiary reinforced structural element, the first subsidiary reinforced structural element extends towards a center of the vibration plate main body, the second subsidiary reinforced structural element is in a shape of a curve, the first subsidiary reinforced structural element connects to a portion of the second subsidiary reinforced structural element between two ends of the second subsidiary reinforced structural element.

12. A speaker, comprising:
a base frame; and
a vibration plate disposed above the base frame, the vibration plate comprising a vibration plate main body and a reinforced structural element, the vibration plate main body having a first surface and a second surface opposite to each other, the reinforced structural element being located between the first surface and the second surface,
wherein a material of the vibration plate main body is different from a material of the reinforced structural element.
